(19) United States
(12) Patent Application Publication
(10) Pub. No.: US 2025/0093895 A1
(43) Pub. Date: Mar. 20, 2025

(54) CONTROLLING OPERATION OF A CONFINEMENT APPARATUS USING INDIVIDUALIZED BROADCASTED VOLTAGE SIGNALS

(71) Applicant: Quantinuum LLC, Broomfield, CO (US)

(72) Inventors: Leonardo ASCARRUNZ, Lafayette, CO (US); Kyle Stephen MCKAY, Broomfield, CO (US); David Kurt LIEFER, Arvada, CO (US); Alex CHERNOGUZOV, Warrington, PA (US)

(21) Appl. No.: 18/830,999

(22) Filed: Sep. 11, 2024

Related U.S. Application Data
(60) Provisional application No. 63/583,629, filed on Sep. 19, 2023.

(51) Int. Cl. G05F 1/46

(52) U.S. Cl. CPC G05F 1/46

(57) ABSTRACT

A system includes a confinement apparatus, arbitrary waveform generators (AWGs), and channel-dedicated signal processing assemblies. Application of respective voltage signals to the plurality of control electrodes of the confinement apparatus is configured to cause the confinement apparatus to confine manipulatable objects. The AWGs are operable to generate respective waveforms. Each signal processing assembly is configured to condition a voltage signal applied to a respective electrode of the confinement apparatus. The signal processing assembly includes a channel-dedicated voltage generator and an operational amplifier. The operational amplifier is configured to receive (i) a broadcasted waveform generated by an AWG and broadcasted to at least two signal processing assemblies of the plurality of channel-dedicated signal processing assemblies and (ii) a quasi-static voltage generated by the channel-dedicated voltage generator. The operational amplifier is configured to output a combined signal generated by combining the broadcasted waveform and the quasi-static voltage.

### CROSS-REFERENCE TO RELATED APPLICATIONS

This application claims priority to U.S. Application No. 63/583,629, filed Sep. 19, 2023, the content of which is incorporated herein by reference in its entirety.

### FIELD

Various embodiments relate to the use of individualized broadcasted voltage signals in the operation of a confinement apparatus. For example, an example embodiment relates to the use of broadcasted voltage signals that are generated by arbitrary waveform generators (AWGs) and individualized for each channel.

### BACKGROUND

Some example confinement apparatuses are operated by applying voltage signals to respective electrodes of the confinement apparatus. In some systems, the voltage signals are generated by AWGs to take advantage of the flexibility provided thereby. However, AWGs tend to be physically large, technically complex, use a significant amount of electrical power, and have complex control requirements. Through applied effort, ingenuity, and innovation many deficiencies of prior systems and techniques have been solved by developing solutions that are structured in accordance with the embodiments of the present invention, many examples of which are described in detail herein.

### BRIEF SUMMARY OF EXAMPLE EMBODIMENTS

Various embodiments provide systems and methods corresponding to operating a confinement apparatus using broadcasted AWG-generated voltage signals that are individualized for various electrical channels of the system. In various embodiments, systems and/or methods are provided for operating a confinement apparatus by applying combined signals to electrodes of the confinement apparatus. A respective combined signal is generated by combining a broadcasted waveform generated by an AWG with a quasi-static voltage generated by a respective channel-dedicated voltage generator. For example, a channel-dedicated signal processing assembly including a respective channel-dedicated voltage generator may receive a broadcasted waveform generated by an AWG and a control signal generated by a controller of the system and provide a respective combined signal.

In various embodiments, the confinement apparatus is operable to confine one or more manipulatable objects. In an example embodiment, the confinement apparatus is a surface ion trap and the manipulatable objects are ions. In various embodiments, the confinement apparatus is an electrical potential trap, an optical trap, a magneto trap, and/or the like and the manipulatable objects are neutral or ionic atoms; neutral, charged, or multipolar molecules; quantum particles; quantum dots; and/or the like.

In an example system, according to an example embodiment, includes a confinement apparatus comprising a plurality of electrodes. Application of respective voltage signals to the plurality of electrodes is configured to cause the confinement apparatus to confine one or more manipulatable objects. The example system further includes one or more arbitrary waveform generators (AWGs), wherein the one or more AWGs are operable to generate respective waveforms; and a plurality of channel-dedicated signal processing assemblies. Each signal processing assembly of the plurality of channel-dedicated signal processing assemblies is configured to condition a voltage signal applied to a respective electrode of the plurality of electrodes. An example channel-dedicated signal processing assembly includes a channel-dedicated voltage generator, and an operational amplifier. The operational amplifier is configured to receive (i) a broadcasted waveform generated by an AWG of the one or more AWGs and that is broadcasted to at least two different channel-dedicated signal processing units and (ii) a quasi-static voltage generated by the channel-dedicated voltage generator. The operational amplifier is configured to output a combined signal generated by combining the broadcasted waveform and the quasi-static voltage. The combined signal may then be provided to a respective electrode of the plurality of electrodes.

According to a first aspect a system is provided. In an example embodiment, the system includes a confinement apparatus comprising a plurality of electrodes. Application of respective voltage signals to the plurality of electrodes is configured to cause the confinement apparatus to confine one or more manipulatable objects. The system further includes one or more arbitrary waveform generators (AWGs), wherein the one or more AWGs are operable to generate respective waveforms. The system further includes a plurality of channel-dedicated signal processing assemblies, wherein each signal processing assembly of the plurality of channel-dedicated signal processing assemblies is configured to condition a voltage signal applied to a respective electrode of the plurality of electrodes. The signal processing assembly comprises a channel-dedicated voltage generator, and an operational amplifier. The operational amplifier is configured to receive (i) a broadcasted waveform generated by an AWG of the one or more AWGs and that is broadcasted to at least two signal processing assemblies of the plurality of channel-dedicated signal processing assemblies and (ii) a quasi-static voltage generated by the channel-dedicated voltage generator. The operational amplifier is configured to output a combined signal generated by combining the broadcasted waveform and the quasi-static voltage.

In an example embodiment, the channel-dedicated voltage generator is a digital-analog converter (DAC).

In an example embodiment, a quantity of AWGs in the one or more AWGs is less than a quantity of electrodes in the plurality of electrodes and a quantity of the plurality of channel-dedicated signal processing assemblies is equal to or less than the quantity of electrodes.

In an example embodiment, a quantity of AWGs in the one or more AWGs is less than a quantity of the plurality of channel-dedicated signal processing assemblies.

In an example embodiment, the signal processing assembly comprises at least one filter configured to filter the combined signal.

In an example embodiment, the operational amplifier is configured to amplify the combined signal such that a filtered combined signal generated by filtering the combined signal by the at least one filter has a desired amplitude.

In an example embodiment, the system further includes a controller configured to control operation of the one or more AWGs and the plurality of channel-dedicated signal processing assemblies.

In an example embodiment, the system further includes a plurality of calibration sensors, each calibration sensor configured to perform a calibration measurement corresponding to a respective location of the confinement apparatus and provide a respective sensor signal for receipt by the controller.

In an example embodiment, the controller is configured to determine the quasi-static voltage to be generated by a respective channel-dedicated voltage generator based on respective sensor signals generated and provided by one or more calibration sensors of the plurality of calibration sensors.

In an example embodiment, the quasi-static voltage is determined based on an existing electric field or electric potential at a particular location of the confinement apparatus determined based at least in part the respective sensor signals and a desired electric field or electric potential at the particular location.

In an example embodiment, the combined signal is applied to a respective electrode of the plurality of electrodes corresponding to the signal processing assembly.

In an example embodiment, each of the respective waveforms generated by the one or more AWGs are provided to a respective plurality of the channel-dedicated signal processing assemblies.

In an example embodiment, the one or more AWGs comprises a first AWG and a second AWG and the broadcasted waveform is a switchable one of a first waveform generated by the first AWG or a second waveform generated by the second AWG is provided to the signal processing assembly.

In an example embodiment, the system is a quantum charge-coupled device (QCCD)-based quantum computer.

According to another aspect, a method of controlling operation of a confinement apparatus using individualized broadcasted waveforms is provided. In an example embodiment, the method comprises determining, by a controller, a desired electric field or electric potential at a particular location defined by a confinement apparatus, wherein the confinement apparatus comprises one or more electrodes; and determining, by the controller, respective quasi-static voltages to be provided to the one or more electrodes to cause an electric field or electric potential at the particular location to be the desired electric field or electric potential. The quasi-static voltage is determined based at least in part on a respective broadcasted waveform to be provided to the one or more electrodes and the desired electric field or electric potential. The method further includes controlling, by the controller, respective channel-dedicated voltage generators of respective channel-dedicated signal processing assemblies to cause the respective channel-dedicated voltage generators to generate the respective quasi-static voltages. Respective operational amplifiers of the respective channel-dedicated respective channel-dedicated signal processing assemblies receive the respective broadcasted waveform and the respective quasi-static voltages and generate respective combined signals based thereon. The respective combined signals are applied to respective electrodes of the one or more electrodes.

In an example embodiment, the method further includes receiving one or more sensor signals, the one or more sensor signals generated by respective calibration sensors and indicating respective calibration measurements, wherein the respective calibration measurements indicate a current electric field or electric potential at the particular location.

In an example embodiment, the respective quasi-static voltages are determined based at least in part on the current electric field or electric potential at the particular location.

In an example embodiment, the respective channel-dedicated signal processing assemblies comprise respective filters configured to filter the respective combined signals prior to the respective combined signals are applied to the respective electrodes.

In an example embodiment, the respective operational amplifiers are operated to amplify the respective combined signals such that respective filtered combined signals generated by filtering the respective combined signals by the respective filters have desired respective amplitudes.

In an example embodiment, the respective broadcasted waveform is provided to a plurality of the respective channel-dedicated voltage generators.

In an example embodiment, the respective broadcasted waveform is generated by an arbitrary waveform generator (AWG) and the respective channel-dedicated voltage generators are digital analog converters (DACs).

According to another aspect, a controller comprising one or more processors, memory storing computer-executable instructions, one or more driver controller elements configured to control operation of respective AWGs or respective channel-dedicated voltage generators, and one or more digital to analog converters configured for receiving sensor signals. Execution of the computer-executable instructions by the one or more processors causes the controller to perform the method of determining a desired electric field or electric potential at a particular location defined by a confinement apparatus, wherein the confinement apparatus comprises one or more electrodes; and determining respective quasi-static voltages to be provided to the one or more electrodes to cause an electric field or electric potential at the particular location to be the desired electric field or electric potential. The quasi-static voltage is determined based at least in part on a respective broadcasted waveform to be provided to the one or more electrodes and the desired electric field or electric potential. The method further includes controlling respective channel-dedicated voltage generators of respective channel-dedicated signal processing assemblies to cause the respective channel-dedicated voltage generators to generate the respective quasi-static voltages. Respective operational amplifiers of the respective channel-dedicated respective channel-dedicated signal processing assemblies receive the respective broadcasted waveform and the respective quasi-static voltages and generate respective combined signals based thereon. The respective combined signals are applied to respective electrodes of the one or more electrodes.

In an example embodiment, the method further includes receiving one or more sensor signals, the one or more sensor signals generated by respective calibration sensors and indicating respective calibration measurements, wherein the respective calibration measurements indicate a current electric field or electric potential at the particular location.

In an example embodiment, the respective quasi-static voltages are determined based at least in part on the current electric field or electric potential at the particular location.

In an example embodiment, the respective channel-dedicated signal processing assemblies comprise respective filters configured to filter the respective combined signals prior to the respective combined signals are applied to the respective electrodes.

In an example embodiment, the respective operational amplifiers are operated to amplify the respective combined signals such that respective filtered combined signals generated by filtering the respective combined signals by the respective filters have desired respective amplitudes.

In an example embodiment, the respective broadcasted waveform is provided to a plurality of the respective channel-dedicated voltage generators.

In an example embodiment, the respective broadcasted waveform is generated by an arbitrary waveform generator (AWG) and the respective channel-dedicated voltage generators are digital analog converters (DACs).

A computer program product comprising at least one non-transitory storage media storing computer-executable instructions, the computer-executable instructions configured to, when executed by a processor of a controller, cause the controller to perform the method of determining a desired electric field or electric potential at a particular location defined by a confinement apparatus, wherein the confinement apparatus comprises one or more electrodes; and determining respective quasi-static voltages to be provided to the one or more electrodes to cause an electric field or electric potential at the particular location to be the desired electric field or electric potential. The quasi-static voltage is determined based at least in part on a respective broadcasted waveform to be provided to the one or more electrodes and the desired electric field or electric potential. The method further includes controlling respective channel-dedicated voltage generators of respective channel-dedicated signal processing assemblies to cause the respective channel-dedicated voltage generators to generate the respective quasi-static voltages. Respective operational amplifiers of the respective channel-dedicated respective channel-dedicated signal processing assemblies receive the respective broadcasted waveform and the respective quasi-static voltages and generate respective combined signals based thereon. The respective combined signals are applied to respective electrodes of the one or more electrodes.

In an example embodiment, the method further includes receiving one or more sensor signals, the one or more sensor signals generated by respective calibration sensors and indicating respective calibration measurements, wherein the respective calibration measurements indicate a current electric field or electric potential at the particular location.

In an example embodiment, the respective quasi-static voltages are determined based at least in part on the current electric field or electric potential at the particular location.

In an example embodiment, the respective channel-dedicated signal processing assemblies comprise respective filters configured to filter the respective combined signals prior to the respective combined signals are applied to the respective electrodes.

In an example embodiment, the respective operational amplifiers are operated to amplify the respective combined signals such that respective filtered combined signals generated by filtering the respective combined signals by the respective filters have desired respective amplitudes.

In an example embodiment, the respective broadcasted waveform is provided to a plurality of the respective channel-dedicated voltage generators.

In an example embodiment, the respective broadcasted waveform is generated by an arbitrary waveform generator (AWG) and the respective channel-dedicated voltage generators are digital analog converters (DACs).

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides a schematic diagram illustrating an example system comprising a confinement apparatus and combined signal voltage sources, according to an example embodiment.

FIG. 2 provides a top view of a portion of an example confinement apparatus, according to an example embodiment.

FIG. 3 provides a schematic diagram of a portion of the voltage sources used to generate and provide voltage signals to electrodes of the confinement apparatus, according to an example embodiment.

FIG. 4 provides a schematic diagram of an example channel-dedicated signal processing assembly, according to an example embodiment.

FIG. 5 provides a schematic diagram of an example controller of a system including a confinement apparatus and combined signal voltage sources, according to various embodiments.

FIG. 6 provides a flowchart illustrating various processes, procedures, and/or operations performed by a controller of FIG. 5, for example, for controlling a confinement apparatus using individualized broadcasted waveforms, according to an example embodiment.

FIG. 7 provides a schematic diagram of an example computing entity of a quantum computer system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

In various embodiments, a system may utilize broadcasted waveforms that are individualized for respective channels of the system. For example, in an example embodiment, a system includes a confinement apparatus comprising a plurality of electrodes. For example, the confinement apparatus may be a surface ion trap comprising a plurality of electrodes configured to generate at least a portion of a trapping potential configured to confine one or more manipulatable objects (e.g., ions, atoms, molecules, quantum particles, quantum dots, and/or the like) when appropriate voltage signals are applied thereto. In various embodiments, the system includes one or more arbitrary waveform generators (AWGs) each configured to generate a respective broadcasted waveform. In various embodiments, a broadcasted waveform is a voltage signal that may vary with time and that is provided to two or more channels of the system. Each of the channels of the system corresponds to a particular electrode of the plurality of electrodes of the confinement apparatus.

The system further includes a plurality of channel-dedicated signal processing assemblies. For example, for each electrode of the plurality of electrodes is associated with a respective channel-dedicated signal processing assembly. A respective channel-dedicated signal processing assembly is configured to condition and/or individualize the broadcasted waveform to be provided to the corresponding electrode. For example, a respective channel-dedicated signal processing assembly includes a channel-dedicated voltage generator (e.g., a digital analog converter (DAC), and/or the like) and a signal mixer (e.g., an operational amplifier). The signal mixer combines the broadcasted waveform to be provided to the respective electrode with a quasi-static voltage generated by the channel-dedicated voltage generator to generate a combined signal. The combined signal is then applied to the respective electrode. The quasi-static voltage signal is a voltage signal that has an update time that is slower than the update time corresponding to the one or more AWGs and/or the broadcasted waveforms such that the quasi-static voltage is substantially constant over several update cycles of the one or more AWGs and/or the broadcasted waveforms.

In various systems, the flexibility of waveforms generated by AWGs may be desired. For example, the flexibility of waveforms generated by AWGs may enable the efficient and controlled transport of ions within an ion trap when the waveforms are applied to electrodes of the ion trap. For example, AWGs enable flexibility in waveforms that is not possible from other voltage signal generators (e.g., DACs). However, AWGs tend to be physically large, use a significant amount of electrical power, be technically complex, have complex control requirements, and be expensive. Thus, for systems having a large number of channels (e.g., a large number of electrodes) having channel-dedicated AWGs becomes untenable. Therefore, technical problems exist regarding how to generate and provide voltage signals to electrodes of a system with the required flexibility of the voltage signals while not requiring channel-dedicated AWGs (e.g., an AWG for each electrode).

One possible solution to these technical challenges is to use broadcasted waveforms, where a waveform voltage signal is provided or broadcasted to multiple electrodes. However, due to stray electrical fields in the vicinity of the confinement apparatus, the electrical potentials resulting at various locations of the confinement apparatus due to the broadcasted waveforms being applied to the electrodes may not be able to perform the transport of manipulatable objects confined by the confinement apparatus with sufficient accuracy and/or low enough noise. Therefore, technical problems exist regarding how to generate and provide voltage signals to electrodes of a system with the required flexibility of the voltage signals while not requiring channel-dedicated AWGs (e.g., an AWG for each electrode) even when broadcasted waveforms are used.

Various embodiments provide technical solutions to these technical problems. For example, in various embodiments, for each channel (e.g., each electrode), a channel-dedicated signal processing assembly generates a combined signal that is formed by combining a broadcasted waveform with an individualized and/or channel specific quasi-static voltage. This enables the use of significantly fewer AWGs than electrodes while still providing individualized and/or channel specific combined signals to be applied to the respective electrodes. Therefore, various embodiments provide the technical advantages of requiring a relatively small number of AWGs (e.g., compared to the number of channels of the system) while still providing an individualized voltage signal for each channel.

### Example System

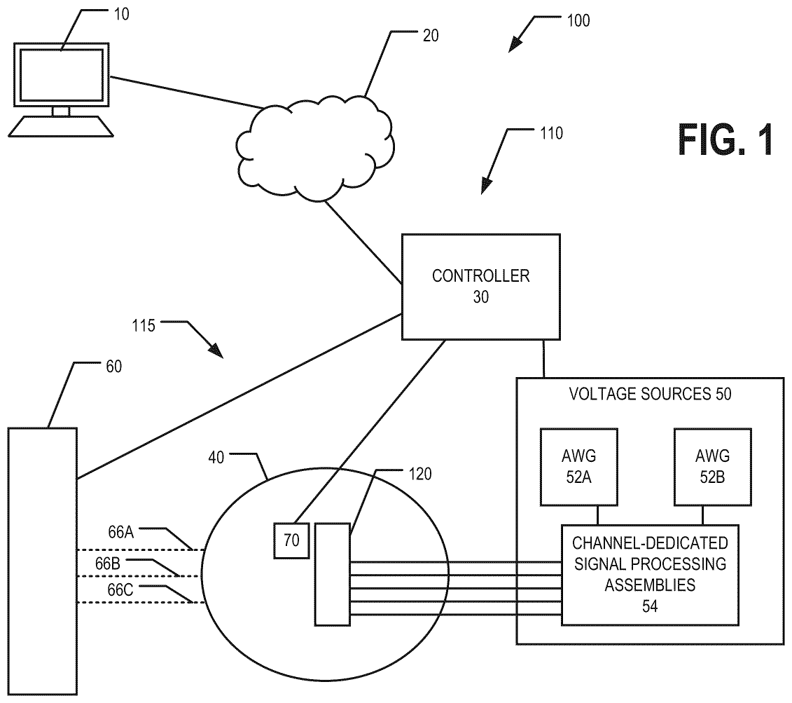

FIG. 1 provides a schematic diagram of an example system 100 in accordance with an example embodiment. The system 100 illustrated in FIG. 1 is a quantum charge-coupled device (QCCD)-based quantum computing system. However, various other systems including a plurality of channels may employ various aspects of various embodiments, as appropriate for the respective applications.

In various embodiments, the system 100 comprises a computing entity 10 and a quantum computer 110. In various embodiments, the quantum computer 110 comprises a controller 30 and a quantum processor 115 including a cryostat and/or vacuum chamber 40 enclosing a confinement apparatus 120 (e.g., an ion trap or other apparatus configured to confine manipulatable objects), and one or more manipulation sources 60 (e.g., lasers, microwave sources, and/or the like). For example, the cryostat and/or vacuum chamber 40 may be a temperature and/or pressure-controlled chamber.

In an example embodiment, the manipulation signals generated by the manipulation sources 60 are provided to the interior of the cryostat and/or vacuum chamber 40 (where the confinement apparatus 120 is located) via corresponding optical path systems 66 (e.g., 66A, 66B, 66C). In various embodiments, the optical path systems 66 are defined, at least in part by one or more components and/or elements (e.g., optical fiber(s), free space optics, waveguides, modulators, and/or the like) of a signal management system.

In an example embodiment, at least one manipulation source 60 is disposed within the cryostat and/or vacuum chamber 40. For example, in an example embodiment, one or more manipulation sources 60 are formed and/or disposed at least in part on and/or in the first substrate on which the confinement apparatus 120 is formed and/or disposed and/or on a second substrate that is mounted in a secured and/or controllable manner with respect to the confinement apparatus 120 within the cryostat and/or vacuum chamber 40.

In an example embodiment, the one or more manipulation sources 60 may comprise one or more coherent optical sources and/or one or more incoherent optical sources. For example, in an example embodiment, the one or more manipulation sources 60 comprise one or more lasers (e.g., optical lasers, microwave sources, VECSELs, VCSELs, and/or the like). In various embodiments, each manipulation source 60 is configured to generate a manipulation signal having a respective characteristic wavelength in the microwave, infrared, visible, or ultraviolet portion of the electromagnetic spectrum. In various embodiments, the one or more manipulation sources 60 are configured to manipulate and/or cause a controlled quantum state evolution of one or more manipulatable objects confined by the confinement apparatus 120. For example, in an example embodiment, wherein the one or more manipulation sources 60 comprise one or more lasers, the lasers may provide one or more laser beams (e.g., as manipulation signals) to manipulatable objects confined and/or trapped by the confinement apparatus 120 within the cryostat and/or vacuum chamber 40.

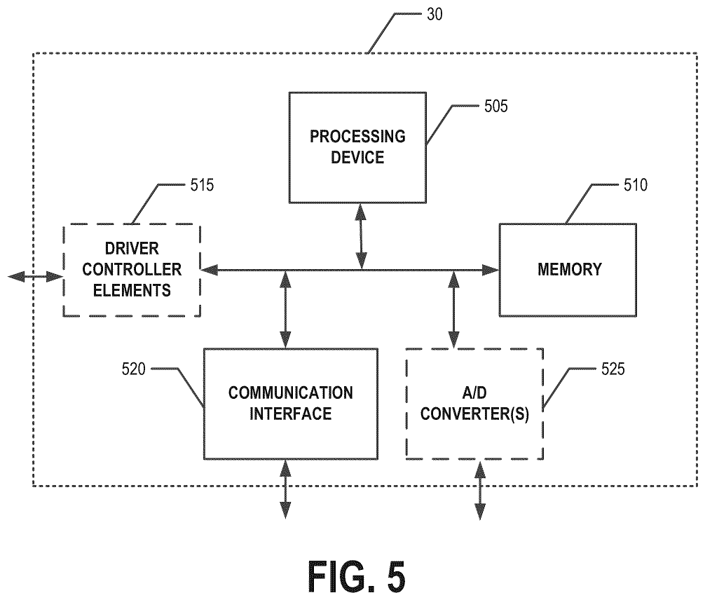

In various embodiments, the quantum computer 110 comprises an optics collection system configured to collect and/or detect photons generated by manipulatable objects and/or qubits (e.g., during qubit reading procedures and/or fluorescence detection processes). The optics collection system may comprise one or more optical elements (e.g., lenses, mirrors, waveguides, fiber optics cables, and/or the like) and one or more photodetectors. For example, in various embodiments the one or more optical elements are configured to direct light and/or photons generated and/or emitted by a manipulatable object toward a respective photodetector. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the manipulatable objects confined by the confinement apparatus 120. In various embodiments, the photodetectors are in electronic communication with the controller 30 via one or more A/D converters 525 (see FIG. 5) and/or the like.

In various embodiments, the quantum computer 110 comprises voltage sources 50. In various embodiments, the voltage sources 50 generate and provide voltage signals that, when applied to respective electrodes of the confinement apparatus 120, cause the confinement apparatus to generate one or more potential wells configured for confining one or more manipulatable objects. In various embodiments, the voltage sources 50 comprise one or more radio frequency (RF) drivers and/or voltage sources. In various embodiments, the voltage sources 50 further include one or more AWGs 52 (e.g., 52A, 52B) and a plurality of channel-dedicated signal processing assemblies 54. In various embodiments, the voltage sources 50 include as many (e.g., the same quantity of) channel-dedicated signal processing assemblies 54 as there are channels and/or electrodes of the confinement apparatus 120. In some embodiments, each channel is associated with and/or in electrical communication with a single respective electrode of the confinement apparatus 120. In certain embodiments, at least one channel is associated with and/or in electrical communication with two or more electrodes of the confinement apparatus 120. In various embodiments, the voltage sources 50 include (significantly) fewer AWGs 52 than there are channels and/or electrodes of the confinement apparatus 120.

In various embodiments, a respective channel-dedicated signal processing assembly 54 is electrically coupled to at least one AWG 52. In various embodiments, a respective channel-dedicated signal processing assembly 54 is electrically coupled to two or more AWGs 52 in a switchable manner. For example, a respective channel-dedicated signal processing assembly 54 is configured to receive a broadcasted waveform generated by a selected AWG 52 as input and provide a combined signal that is an individualized and/or channel specific version of the broadcasted waveform to a respective electrode of the confinement apparatus 120.

In various embodiments, the system 100 further includes calibration sensors 70. In various embodiments, the calibration sensors 70 includes sensors configured to measure an electric potential or electric field at a respective location of the confinement apparatus 120. For example, each calibration sensor 70 is configured to regularly, periodically, and/or in a triggered manner perform a calibration measurement at a respective location of the confinement apparatus and provide a respective sensor signal for receipt by the controller 30 (e.g., via A/D converter 525). In various embodiments, the sensor signal generated by a calibration sensor 70 directly or indirectly provides an indication of the current electric field and/or electric potential at the respective location of the confinement apparatus 120. For example, the calibration sensors 70 enable the controller 30 to monitor the current electric field and/or electric potential a respective locations of the confinement apparatus 120 before, during, and/or after operation of the system 100.

In an example embodiment, a calibration sensor 70 includes a photon detector (e.g., photomultiplier tube (PMT), charge coupled device (CCD), single photon avalanche diode (SPAD), and/or other photodetector). For example, a manipulatable object may be illuminated with a manipulation signal (e.g., laser beam) characterized by a particular wavelength, polarization, and/or the like. For example, the controller 30 may control a manipulation source 60 and corresponding beam path system 66 to cause a manipulation signal to be incident on the manipulatable object. Scattering of light from the manipulation signal off the manipulatable object is influenced by the electric field at the location of the manipulatable object and/or one or more previous locations of the manipulatable object. Collection optics may be used to direct and/or guide the scattered light to the photon detector.

The photon detector of the calibration sensor 70 is configured to detect light scattered off the manipulatable object. The amount of light and/or number of photons detected by the photon detector of the calibration sensor is therefore influenced by the electric field at the current location and/or a previous location of the manipulation object. The amount of light and/or number of photons detected by the photon detector is encoded into the sensor signal generated by the photon detector and provided to the controller 30. The controller 30 can then determine a measure or indication of the electric field (e.g., based on a stored function, formula, look-up table, and/or the like) at the current location of the manipulatable object or a previous location of the manipulatable object.

In various embodiments, a (classical and/or semiconductor-based) computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms and/or circuits, and/or the like into a computing language, executable instructions, command sets, and/or the like that the controller 30 can understand and/or implement.

In various embodiments, the controller 30 is a classical and/or semiconductor-based computing device configured to control operation of the voltage sources 50, cryostat system and/or vacuum system controlling the temperature and pressure within the cryostat and/or vacuum chamber 40, manipulation sources 60, optics collection system, calibration sensors 70, and/or other systems controlling various environmental conditions (e.g., temperature, pressure, and/or the like) within the cryostat and/or vacuum chamber 40 and/or configured to manipulate and/or cause a controlled evolution of quantum states of one or more manipulatable object confined by the confinement apparatus 120. For example, the controller 30 may cause a controlled evolution of quantum states of one or more manipulatable objects confined by the confinement apparatus 120 to execute a quantum circuit and/or algorithm. In various embodiments, the controller 30 is configured to receive and process sensor signals (generated and/or provided by calibration sensors 70) to determine and/or characterize a current electric field and/or electric potential at respective locations of the confinement apparatus 120. In various embodiments, the at least some of the manipulatable objects confined by the confinement apparatus 120 are used as qubits of the quantum processor 115 of the quantum computer 110.

### Example Confinement Apparatus

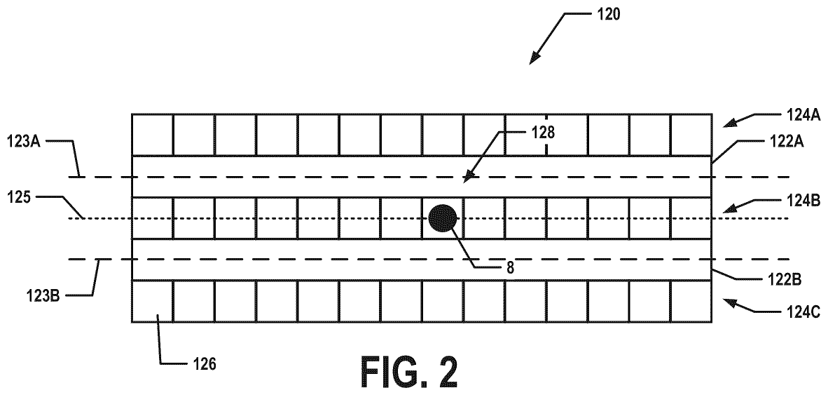

In various embodiments, the confinement apparatus 120 is configured to confine one or more manipulatable objects. In an example embodiment, the manipulable objects are ions and the confinement apparatus 120 is a surface ion trap or a Paul ion trap. A portion of such an example confinement apparatus 120 is illustrated in FIG. 2.

FIG. 2 illustrates a top view of a portion of an example confinement apparatus 120. The illustrated portion of the confinement apparatus 120 includes radio frequency (RF) rails 122A, 122B and three sequences of control electrodes 124A, 124B, 124C. Each sequence of control electrodes 124 comprises a plurality of control electrodes 126.

In various embodiments each control electrode 126 corresponds to, is associated with, and/or is electrically coupled to a respective channel-dedicated signal processing assembly 54. For example, each control electrode 126 corresponds to and/or defines a respective channel of the confinement apparatus 120 and/or system 100. For example, the individualized and/or channel specific broadcasted waveforms are applied to the control electrodes 126. In various embodiments, the individualized and/or channel specific broadcasted waveforms are applied to the control electrodes 126 to control the location of manipulatable objects along linear confinement regions defined by the RF rails 122A, 122B.

In various embodiments, RF voltage sources of the voltage sources 50 generate and provide an RF voltage signal that is applied to the RF rails 122A, 122B to generate a pseudopotential that defines one or more linear confinement regions (e.g., a 2 or 3-dimensional array of 1-dimensional confinement regions). The manipulatable objects 8 confined by the confinement apparatus 120 are confined in the one or more linear confinement regions.

In various embodiments, the RF rails 122A, 122B define (at least locally) respective longitudinal axes 123A, 123B. The RF voltage signal applied to the RF rails 122A, 122B generates a pseudopotential having an RF null axis 125. In general, the manipulatable objects 8 are disposed along the RF null axis 125.

The atomic objects may be maintained at and/or transported between different locations of the confinement apparatus 120 through the application waveforms to the control electrodes 126. FIG. 2 shows the manipulatable object 8 being maintained along the RF null axis 125 at a particular location 128. The particular location 128 is defined at least in part by the confinement apparatus 120.

For example, in various embodiments, the confinement apparatus 120 may be similar to a confinement apparatus disclosed by U.S. Pat. Nos. 11,037,776; 11,600,482; U.S. application Ser. No. 17/533,587, filed Nov. 23, 2021; U.S. application Ser. No. 17/810,082, filed Jun. 20, 2022; or U.S. Application No. 63/481,665, filed Jan. 26, 2023, the contents of which are hereby incorporated by reference herein in their entireties.

### Example Voltage Sources

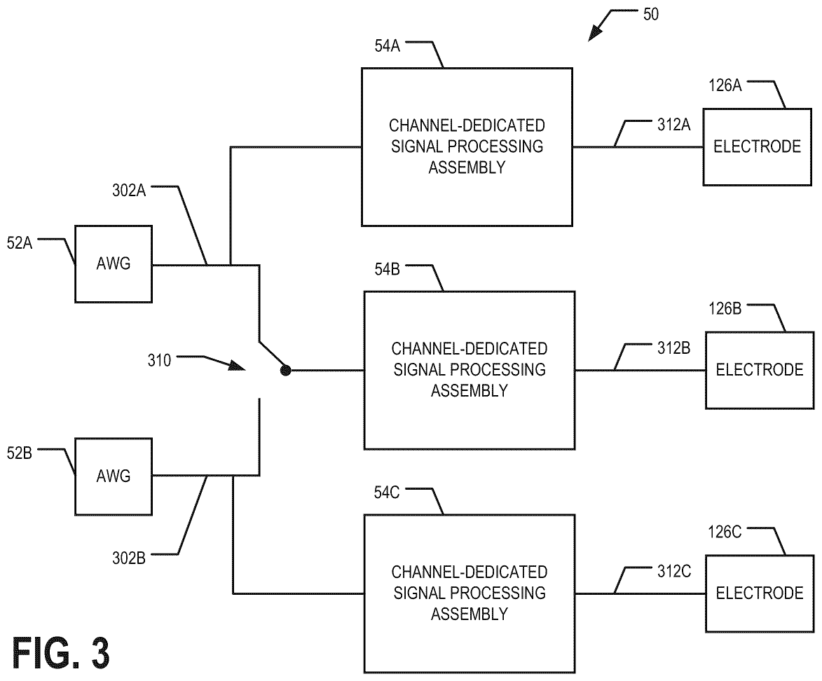

FIG. 3 illustrates at least a portion of example voltage sources 50. For example, the voltage sources include AWGs 52A, 52B and channel-dedicated signal processing assemblies 54A, 54B, 54C. Each of the AWGs 52A, 52B generates a respective broadcasted signal 302A, 302B. A respective broadcasted waveform 302A, 302B is provided to each channel-dedicated signal processing assembly 54A, 54B, 54C.

In various embodiments, a channel-dedicated signal processing assembly 54B is in electrical connection with a respective AWG 52A, 52B via a switch 310. Thus, the broadcasted waveform 302 provided to the channel-dedicated signal processing assembly 54B is switchable between a first broadcasted waveform 302A generated by a first AWG 52A and a second broadcasted waveform 302B generated by a second AWG 52B. In various embodiments, each of the channel-dedicated signal processing assemblies 54 is switchably electrically connected and/or coupled to two or more AWGs 52 such that a respective channel-dedicated signal processing assembly 54 receives a selected broadcasted waveform 302. In an example embodiment, one or more channel-dedicated signal processing assemblies 54 are non-switchably electrically connected and/or coupled (e.g., in wired connection without an intervening switch 310) to respective AWGs 52.

A channel-dedicated signal processing assembly 54 receives a respective broadcast waveform 302 as input and individualizes and/or conditions the respective broadcasted waveform 302 to generate and provide an individualized or channel specific broadcasted waveform. For example, in various embodiments, the channel-dedicated signal processing assembly combines the respective broadcasted waveform 302 with a quasi-static voltage and/or other individualized and/or channel-specific voltage signal to generate a combined signal 312 (e.g., 312A, 312B, 312C). The combined signal 312 is an individualized and/or channel specific broadcasted waveform. In other words, the combined signal 312 is a voltage signal that is generated by combining the respective broadcasted waveform 302 with a channel specific voltage and/or voltage signal. The combined signal 312 is then provided to a respective control electrode 126 (e.g., 126A, 126B, 126C) of the confinement apparatus 120. Application of the combined signals 312 to the respective control electrodes 126 of the confinement apparatus 120 causes the electric field and/or electric potential at one or more particular locations of the confinement apparatus 120 to be substantially equal to a desired electric field and/or electric potential at the respective particular locations.

Notably, the voltage sources 50 include fewer AWGs 52 than channel-dedicated signal processing assemblies 54. In particular, the voltage sources 50 include fewer AWGs 52 than channels and/or control electrodes 126 of the confinement apparatus 120. The voltage sources 50 include a channel-dedicated signal processing assembly corresponding to each channel and/or control electrode 126 of the confinement apparatus 120. Thus, a quantity of AWGs 52 included in the voltage sources 50 is less than a quantity of channel-dedicated signal processing assemblies 54 included in the voltage sources 50 and/or a quantity of channels and/or control electrodes 126 of the confinement apparatus 120. A quantity of the channel-dedicated signal processing assemblies 54 included in the voltage sources 50 is equal to the number of channels and/or control electrodes 126 of the confinement apparatus 120.

In some embodiments, each channel is associated with and/or in electrical communication with a single respective electrode of the confinement apparatus 120. In certain embodiments, at least one channel is associated with and/or in electrical communication with two or more electrodes of the confinement apparatus 120. In other words, there is a one-to-one correspondence between channel-dedicated signal processing assemblies 54 and the channels of the confinement apparatus 120. In some embodiments, there is a one-to-one correspondence between channels of the confinement apparatus 120 and control electrodes 126 of the confinement apparatus 120 and, in certain embodiments, there is a one-to-more than one correspondence between channels of the confinement apparatus 120 and control electrodes 126, for at least one channel. For example, FIG. 3 illustrates an example embodiment where there is a one-to-one correspondence between channels and control electrodes 126 of the confinement apparatus. However, in another embodiment, the channel-dedicated signal processing assembly 54C is in electrical communication with electrode 126C and electrode 126D (not shown).

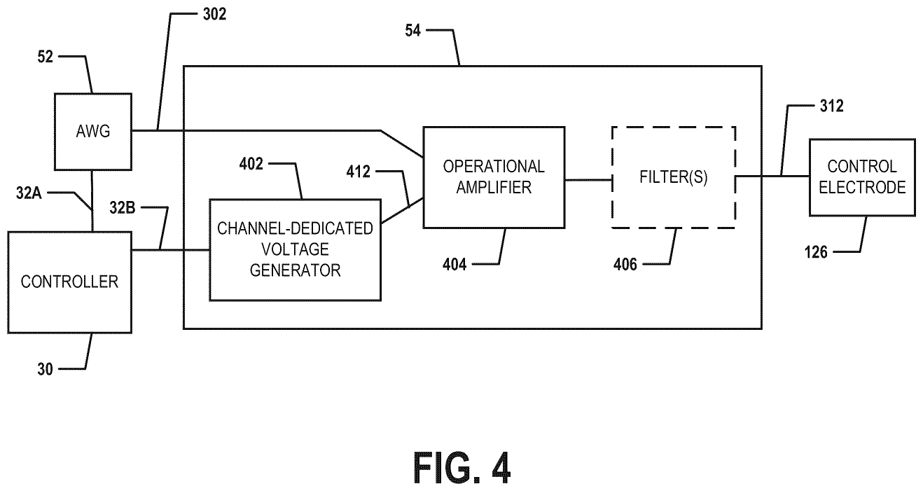

FIG. 4 illustrates an example channel-dedicated signal processing assembly 54 and its respective inputs and outputs. In the illustrated embodiment, the channel-dedicated signal processing assembly 54 includes a channel-dedicated voltage generator 402 and a mixer such as an operational amplifier 404. In various embodiments, the channel-dedicated signal processing assembly 54 further includes one or more filters 406 configured to filter the combined signal.

In various embodiments, the channel-dedicated voltage generator 402 is a DAC. A DAC is physically smaller, technically less complex, has less technical control requirements, less power consumption, and less expensive than an AWG. Thus, various embodiments enable the use of an AWG 52 to generate a flexible waveform (e.g., a voltage signal that may evolve with time in a desired way) with an update frequency in the MHz to GHz range that is supplied and/or broadcasted to a plurality channels. Various embodiments further enable the use of a channel-dedicated voltage generator 402 (e.g., a DAC) to generate a quasi-static voltage 412 (e.g., with an update frequency in the 10s of kHz range) used to individualize the broadcasted waveform for use with the specific channel and/or application to a specific control electrode 126.

In various embodiments, the controller 30 controls an AWG 52 that is (switchably) electrically connected and/or coupled to the channel-dedicated signal processing assembly 54 via an AWG control signal 32A. For example, the receipt and/or processing of the AWG control signal 32A by the AWG 52 causes the AWG 52 to generate a desired waveform that is then broadcasted to a plurality of channel-dedicated signal processing assembly 54.

The controller 30 controls the channel-dedicated voltage generator 402 (e.g., a DAC) to cause the channel-dedicated voltage generator 402 to generate a quasi-static voltage 412. For example, the controller 30 generates and provides a DAC control signal 32B that is provided to the channel-dedicated signal processing assembly 54 (e.g., the channel-dedicated voltage generator 402). Receipt and/or processing of the DAC control signal 32B by the channel-dedicated voltage generator 402 causes the channel-dedicated voltage generator (e.g., DAC) to generate the quasi-static voltage 412. The quasi-static voltage 412 is substantially static and/or constant from the perspective of the broadcast waveform 302 as the update frequency of the AWG 52 is in the MHz to GHz range and the update frequency of the channel-dedicated voltage generator 402 is in the 10s of kHz. A mixer of the channel-dedicated signal processing assembly, such as the operational amplifier 404, receives both the broadcasted waveform 302 and the quasi-static voltage 412 as input. The mixer (e.g., the operational amplifier 404) combines the broadcasted waveform 302 and the quasi-static voltage 412 to generate a combined signal 312.

In various embodiments, the mixer (e.g., operational amplifier 404) provides the combined signal 312 to one or more filters 406. In various embodiments, the one or more filters 406 may include one or more high pass filters, one or more low pass filters, one or more bandpass filters, and/or the like. In various embodiments, the one or more filters 406 include one or more passive filters and/or one or more active filters. In an example embodiment, the one or more filters 406 includes a dynamic filter such as that described by U.S. Pat. No. 11,025,228, the contents of which are incorporated herein by reference. In various embodiments, the one or more filters 406 are appropriate filters for filtering voltage signals for the particular application.

In various embodiments, the operational amplifier 404 is configured to amplify the combined signal 312 so as to drive the filtering and/or other processing performed by the channel-dedicated signal processing assembly 54. For example, the operational amplifier 404 is configured to and/or operated to amplify the combined signal 312 such that the combined signal applied to the corresponding control electrode 126 (e.g., after filtering by the filters 406 and/or after any other processing of the combined signal is performed), the combined signal has a desired amplitude and/or power. For example, the operational amplifier 404 may buffer the combined signal such that, after filtering by the filters 406, a combined signal of a desired amplitude and/or power is applied to the corresponding control electrode 126.

### Example Controller

In various embodiments, a confinement apparatus 120 is incorporated into a system (e.g., a quantum computer 110 or other atomic and/or quantum system) comprising a controller 30. In various embodiments, the controller is a classical or semiconductor-based computing device. In various embodiments, the controller 30 is configured to control various elements of the system (e.g., quantum computer 110 or other atomic and/or quantum system). For example, the controller 30 may be configured to control operation of the voltage sources 50 and the manipulation sources 60, in various embodiments. For example, the controller 30 may be configured to control operation of the voltage sources 50 to cause the voltage sources 50 to generate and provide individualized broadcasted waveforms. For example, the voltage sources 50 comprise one or more arbitrary waveform generators (AWGs) 52 (e.g., 52A, 52B) and a plurality of channel-dedicated signal processing assemblies 54. The controller 30 controls operation of the AWGs 52 to cause the AWGs to generate respective waveforms that are broadcasted to respective sets of the channel-dedicated signal processing assemblies. Each of the channel-dedicated signal processing assemblies receives a selected broadcasted waveform and individualizes the broadcasted waveform, based on a respective control signal provided by the controller 30. The individualized broadcasted waveforms are then applied to respective control electrodes 126 of the confinement apparatus 120.

In various embodiments, the controller 30 is configured to control operation of the voltage sources 50, a cryostat system and/or vacuum system controlling the temperature and pressure within the cryostat and/or vacuum chamber 40, manipulation sources 60, cooling system, and/or other systems controlling the environmental conditions (e.g., temperature, humidity, pressure, and/or the like) within the cryostat and/or vacuum chamber 40 and/or other systems configured to manipulate and/or cause a controlled evolution of quantum states of one or more manipulatable objects confined by the confinement apparatus 120. In various embodiments, the controller 30 may be configured to receive sensor signals from one or more optics collection systems and/or calibration sensors 70.

As shown in FIG. 5, in various embodiments, the controller 30 may comprise various controller elements including processing device 505, memory 510, driver controller elements 515, a communication interface 520, analog-digital converter elements 525, and/or the like. For example, the processing device 505 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing device 405 of the controller 30 comprises a clock and/or is in communication with a clock.

For example, the memory 510 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 510 may store a queue of commands and/or executable instructions to be executed to cause a quantum algorithm and/or circuit to be executed (e.g., an executable queue), qubit records corresponding to the qubits of quantum computer (e.g., in a qubit record data store, qubit record database, qubit record table, and/or the like), a calibration table, computer program code (e.g., in a one or more computer languages, specialized controller language(s), and/or the like), and/or the like. In an example embodiment, execution of at least a portion of the computer program code stored in the memory 510 (e.g., by a processing device 505) causes the controller 30 to perform one or more steps, operations, processes, procedures and/or the like described herein for providing manipulation signals to one or more locations and/or collecting, detecting, capturing, and/or measuring indications of emitted signals emitted by manipulatable objects located at corresponding locations of the confinement apparatus 120.

In various embodiments, the driver controller elements 515 may include one or more drivers and/or controller elements each configured to control one or more drivers. In various embodiments, the driver controller elements 515 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 405). In various embodiments, the driver controller elements 515 may enable the controller 30 to operate and/or control operation of voltage sources 50 (e.g., AWGs, DACs, and/or other voltage sources and/or various other (active) components of the channel-dedicated signal processing assemblies), manipulation sources 60 (e.g., lasers, microwave sources), cooling system, and/or the like. In various embodiments, the drivers may be laser drivers configured to operate one or manipulation sources 60 to generate manipulation signals; vacuum component drivers; drivers for controlling the flow of current and/or voltage applied to electrodes used for maintaining and/or controlling the trapping potential of the confinement apparatus 120 (and/or other drivers for providing potential generating signals to potential generating elements of the confinement apparatus); cryostat and/or vacuum system component drivers; cooling system drivers, and/or the like. For example, a first driver controller element 515 generates and provides the AWG control signal 32A and a second driver controller element 515 generates and provides the DAC control signal 32B. Various other driver controller elements 515 generate and provide appropriate control signals to various other components of the quantum processor 115.

In various embodiments, the controller 30 comprises means for communicating and/or receiving sensor signals from one or more optical receiver components (e.g., photodetectors of the optics collection system) and/or calibration sensors 70. For example, the controller 30 may comprise one or more analog-digital converter elements 525 configured to receive signals from one or more optical receiver components (e.g., a photodetector of the optics collection system), calibration sensors 70, and/or the like.

In various embodiments, the controller 30 may comprise a communication interface 520 for interfacing and/or communicating with a computing entity 10. For example, the controller 30 may comprise a communication interface 520 for receiving executable instructions, command sets, and/or the like from the computing entity 10 and providing output received from the quantum computer 110 (e.g., from an optics collection system) and/or the result of a processing the output to the computing entity 10. In various embodiments, the computing entity 10 and the controller 30 may communicate via a direct wired and/or wireless connection and/or via one or more wired and/or wireless networks 20.

### Example Methods for Controlling Operation of the System

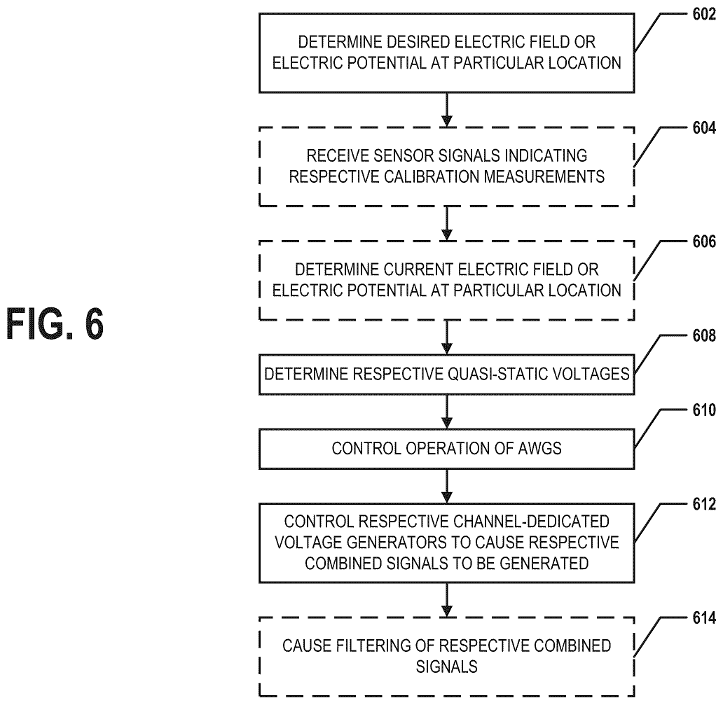

FIG. 6 provides a flowchart illustrating various processes, procedures, operations, and/or the like performed by a controller 30 of a system 100 to control operation of a confinement apparatus using individualized and/or channel specific broadcasted waveforms. For example, in various embodiments, the memory 510 of the controller 30 may store executable instructions that when executed by the processing device 505 cause the controller 30 (e.g., via execution of respective executable instructions by the driver controller elements 515) to control operation of various elements of the system 100 (e.g., AWGs 52, channel-dedicated signal processing assemblies 54, and/or the like) based at least in part on sensor signals received (e.g., via A/D converter(s) 525) and processed (e.g., via processing device 505) by the controller 30.

FIG. 6 is described herein with the example of transporting a manipulatable object from a first location of a confinement apparatus 120 to a second location of the confinement apparatus 120. However, the steps illustrated in FIG. 6 may be performed by the controller 30 to perform various other operations, as appropriate for the application. For example, the controller 30 may perform the steps illustrated in FIG. 6 to maintain a manipulatable object at a first location of the confinement apparatus 120. In another example, the controller 30 may perform the steps illustrated in FIG. 6 to transport a first set of manipulatable object from respective first locations of the confinement apparatus to respective second locations of the confinement apparatus while maintain a second set of manipulable objects at particular locations of the confinement apparatus.

Starting at step 602, the controller 30 determines a desired electric field and/or electric potential at one or more particular locations of the confinement apparatus 120. For example, the controller 30 comprises means, such as processing device 505, memory 510, and/or the like, for determining a desired electric field and/or electric potential at one or more particular locations of the confinement apparatus 120. For example, the controller 30 may be controlling the quantum processor 115 to cause the quantum processor 115 to perform a quantum circuit. The quantum circuit may indicate that a particular manipulatable object should be moved from a first location of the confinement apparatus to a second location of the confinement apparatus 120. The one or more particular locations may include the first location, the second location, and/or one or more locations along a route from the first location to the second location. The desired electric field and/or electric potential at the one or more particular locations is configured to cause the manipulatable object to traverse the route from the first location to the second location. In various embodiments, the desired electric field and/or electric potential evolves with time over a period of time that it will take for the manipulatable object to traverse the route (or a portion thereof) from the first location to the second location.

At step 604, the controller 30 receives sensor signals indicating respective calibration measurements. For example, the controller 30 comprises means, such as processing device 505, memory 510, A/D converters 525, and/or the like, for receiving sensor signals indicating respective calibration measurements.

For example, the system 100 includes one or more calibration sensors 70. In various embodiments, the calibration sensors 70 includes sensors configured to measure an electric potential or electric field at a respective location of the confinement apparatus 120. For example, each calibration sensor 70 is configured to regularly, periodically, and/or in a triggered manner perform a calibration measurement at a respective location of the confinement apparatus 120 and provide a respective sensor signal for receipt by the controller 30 (e.g., via A/D converter 525). In various embodiments, the sensor signal generated by a calibration sensor 70 directly or indirectly provides an indication of the current electric field and/or electric potential at the respective location of the confinement apparatus 120. For example, the calibration sensors 70 enable the controller 30 to monitor the current electric field and/or electric potential at respective locations of the confinement apparatus 120 before, during, and/or after operation of the system 100.

In an example embodiment, the controller 30 controls operation of the confinement apparatus 120 (e.g., via controller driver controller elements 515 controlling respective voltage sources 50) to cause one or more manipulatable objects to be located at respective measurement positions. In an example embodiment, a respective measurement position is a respective location of the confinement apparatus 120 at which the current electric field and/or electric potential is to be measured. In an example embodiment, the manipulatable object is transported through a respective location of the confinement apparatus 120 at which the current electric field and/or electric potential is to be measured enroute to the measurement position. The measurement positions are defined at least in part by the confinement apparatus 120 and/or respective beam path systems 66.

While the respective manipulatable objects are disposed at respective measurements positions, the controller 30 controls operation of one or more manipulation sources 60 and/or respective beam path systems 66 to cause respective manipulation signals (e.g., laser beams characterized by a particular wavelength, polarization, and/or the like) to be incident on the respective measurement positions (and the respective manipulation objects disposed thereat). The photon detectors of respective calibration sensors 70 detect and/or capture photons scattered off respective manipulation objects disposed at respective measurement positions. Based on the photons detected and/or captured, a respective photon detector generates a respective sensor signal and provides the respective sensor signal to the controller 30. The controller 30 then receives the respective sensor signal and determines a measurement or indication of the electric field and/or electric potential at a respective location of the confinement apparatus 120 based the respective sensor signal. For example, the controller 30 may store a (callable, classical) function, formula, lookup table, and/or the like that the controller 30 may use to determine a measurement and/or indication of the electric field and/or electric potential at a respective location of the confinement apparatus 120 based the respective sensor signal.

At step 606, the controller 30 processes the sensor signals to determine and/or characterize the current electric field and/or electric potential at the one or more particular locations. For example, the controller 30 comprises means, such as processing device 505, memory 510, and/or the like, for processing the sensor signals to determine and/or characterize the current electric field and/or electric potential at the one or more particular locations. For example, the controller 30 process the sensor signals to determine the calibration measurements indicated thereby. Based on the calibration measurements, the controller 30 determines the current electric field and/or electric potential at the one or more particular locations. In an example embodiment, the respective locations that the calibration sensors 70 are configured to perform the calibration measurements at are the one or more particular locations. In another example embodiment, the controller 30 is configured to interpolate the current electric field and/or electric potential determined for the respective locations based on the sensor signals to determine the current electric field and/or electric potential for the one or more particular locations.

At step 608, the controller 30 determines the respective quasi-static voltages for each channel of the confinement apparatus 120. For example, the controller 30 comprises means, such as processing device 505, memory 510, and/or the like for determining the quasi-static voltage for each channel of the confinement apparatus 120. In various embodiments, the quasi-static voltages are determined based at least in part on the desired electric field and/or electric potential at the one or more particular locations. For example, the quasi-static voltages are determined and/or configured such that, when the quasi-static voltages are combined with respective broadcasted waveforms and the resulting combined signals are applied to respective control electrodes 126, the electric field and/or electric potential at the one or more particular locations will be the desired electric field and/or electric potential at the one or more particular locations.

In an example embodiment, the quasi-static voltages are determined based at least in part on the desired electric field and/or electric potential at the one or more particular locations and the current electric field and/or electric potential at the one or more particular locations. For example, the quasi-static voltages may be determined, at least in part, based on the sensor signals received by the controller 30. For example, the sensor signals received by the controller 30 may be used to recalibrate the quasi-static voltages required for the electric field and/or electric potential at the one or more particular locations to be the desired electric field and/or electric potential during the transport of the manipulatable object along at least a portion of the route from the first location to the second location.

In various embodiments, a confinement apparatus 120 comprises hundreds of control electrodes 126 and thus hundreds of channels. The controller 30 is configured to determine the respective quasi-static voltages for the respective channels in a fraction of second such that the desired operations may be performed within the coherence time of the qubits of the quantum processor 115 (which are embodied by the manipulatable objects 8 confined by the confinement apparatus 120).

At step 610, the controller 30 controls operation of one or more AWGs 52 to cause the AWGs 52 to generate respective broadcasted waveforms. For example, the controller 30 comprises means, such as processing device 505, memory 510, driver controller elements 515, and/or the like for controlling operation of one or more AWGs 52 to cause the AWGs to generate respective broadcasted waveforms. For example, the processing device 505 may cause a driver controller element 515 to generate and provide an AWG control signal 32A to a respective AWG. The AWG control signal 32A is configured to cause the AWG to generate a respective waveform that is then broadcasted to a plurality of channel-dedicated signal processing assemblies 54.

At step 612, the controller 30 controls operation of one or more channel-dedicated voltage generators 402 (e.g., DACs) to cause the one or more channel-dedicated voltage generators 402 to generate respective quasi-static voltages 412. For example, the controller 30 comprises means, such as processing device 505, memory 510, driver controller elements 515, and/or the like for controlling operation of one or more channel-dedicated voltage generators 402 (e.g., DACs) to cause the one or more channel-dedicated voltage generators to generate respective quasi-static voltages 412. For example, the processing device 505 may cause a driver controller element 515 to generate and provide a DAC control signal 32B to a respective channel-dedicated voltage generator 402. The DAC control signal 32B is configured to cause the channel-dedicated voltage generator 402 (e.g., a DAC) to generate a respective quasi-static voltage 412.

The respective mixers (e.g., operational amplifiers 404) of respective channel-dedicated signal processing assemblies 54 receive the respective broadcasted waveforms 302 and respective quasi-static voltages 412 and generate respective combined signals 312. In an example embodiment, the controller 30 includes one or more driver controller elements 515 configured to control operation of the one or more operational amplifiers 404. For example, the controller 30 may control operation of respective operational amplifiers 404 such that the combined signals applied to respective control electrodes 126 are of a desired amplitude or power. For example, the controller 30 comprises means, such as processing device 505, memory 510, driver controller elements 515, and/or the like for controlling operation of respective operational amplifiers 404 such that the combined signals applied to respective control electrodes 126 are of a desired amplitude or power.

In example embodiments including one or more filters 406, the respective filters 406 of respective channel-dedicated signal processing assemblies 54 filter the combined signals 312 and provide the filtered combined signals. In an example embodiment including one or more filters 406 where the one or more filters 406 include active filters that are controlled by the controller 30, at step 614, the controller 30 controls operation of the one or more active filters to cause the filtering of the respective combined signals. For example, the controller 30 comprises means, such as processing device 505, memory 510, driver controller elements 515, and/or the like for controlling operation of one or more active filters to cause desired filtering of the respective combined signals to be performed.

The combined signals are provided (e.g., along respective electrical connections and/or couplings between the respective channel-dedicated signal processing assemblies 54 and the respective control electrodes 126) to the respective control electrodes 126. Application of respective combined signals to respective control electrodes causes the performance of the desired operation. For example, continuing with the above example, application of the respective combined signals to respective control electrodes 126 causes the manipulatable object to be transported along at least a portion of the route from the first location to the second location.

### Technical Advantages

In various systems, the flexibility of waveforms generated by AWGs may be desired. For example, the flexibility of waveforms generated by AWGs may enable the efficient and controlled transport of ions within an ion trap when the waveforms are applied to electrodes of the ion trap. For example, AWGs enable flexibility in waveforms that is not possible from other voltage signal generators (e.g., DACs). However, AWGs tend to be physically large, use a significant amount of electrical power, be technically complex, have complex control requirements, and be expensive. Thus, for systems having a large number of channels (e.g., a large number of electrodes) having channel-dedicated AWGs becomes untenable. Therefore, technical problems exist regarding how to generate and provide voltage signals to electrodes of a system with the required flexibility of the voltage signals while not requiring channel-dedicated AWGs (e.g., an AWG for each electrode).

One possible solution to these technical challenges is to use broadcasted waveforms, where a waveform voltage signal is provided or broadcasted to multiple electrodes. However, due to stray electrical fields in the vicinity of the confinement apparatus, the electrical potentials resulting at various locations of the confinement apparatus due to the broadcasted waveforms being applied to the electrodes may not be able to perform the transport of manipulatable objects confined by the confinement apparatus with sufficient accuracy and/or low enough noise. Therefore, technical problems exist regarding how to generate and provide voltage signals to electrodes of a system with the required flexibility of the voltage signals while not requiring channel-dedicated AWGs (e.g., an AWG for each electrode) even when broadcasted waveforms are used.

Various embodiments provide technical solutions to these technical problems. For example, in various embodiments, for each channel (e.g., each electrode), a channel-dedicated signal processing assembly generates a combined signal that is formed by combining a broadcasted waveform with an individualized and/or channel specific quasi-static voltage. This enables the use of significantly fewer AWGs than electrodes while still providing individualized and/or channel specific combined signals to be applied to the respective electrodes. Therefore, various embodiments provide the technical advantages of requiring a relatively small number of AWGs (e.g., compared to the number of channels of the system) while still providing an individualized voltage signal for each channel.

### Example Computing Entity

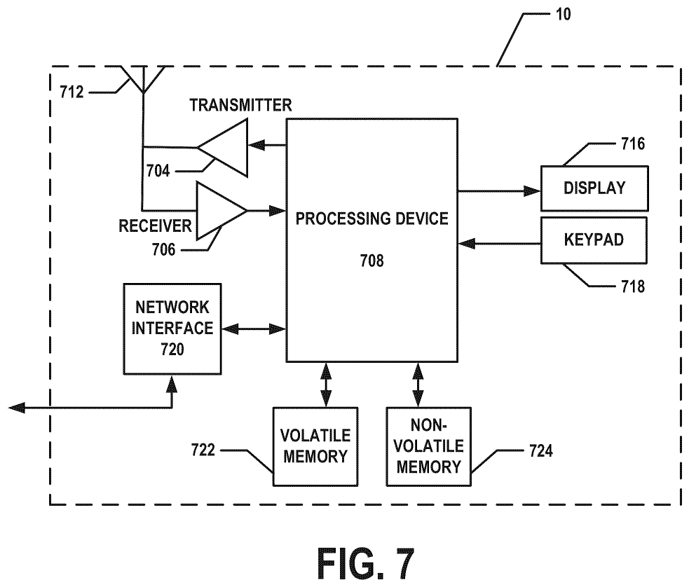

FIG. 7 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 7, a computing entity 10 can include an antenna 712, a transmitter 704 (e.g., radio), a receiver 706 (e.g., radio), and a processing device 708 that provides signals to and receives signals from the transmitter 704 and receiver 706, respectively. The signals provided to and received from the transmitter 704 and the receiver 706, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

For example, the processing device 708 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products.

In various embodiments, the computing entity 10 may comprise a network interface 720 for interfacing and/or communicating with the controller 30, for example, via one or more wired and/or wireless networks. For example, the computing entity 10 may comprise a network interface 720 for providing executable instructions, command sets, and/or the like for receipt by the controller 30 and/or receiving output and/or the result of a processing the output provided by the quantum computer 110. In various embodiments, the computing entity 10 and the controller 30 may communicate via a direct wired and/or wireless connection and/or via one or more wired and/or wireless networks 20.

The computing entity 10 may also comprise a user interface device comprising one or more user input/output interfaces (e.g., a display 716 and/or speaker/speaker driver coupled to a processing device 708 and a touch screen, keyboard, mouse, and/or microphone coupled to a processing device 708). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 718 (hard or soft), a touch display, voice/speech or motion interfaces, scanners, readers, or other input device. In embodiments including a keypad 718, the keypad 718 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 722 and/or non-volatile storage or memory 724, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system comprising:
a confinement apparatus comprising a plurality of electrodes, wherein application of respective voltage signals to the plurality of electrodes is configured to cause the confinement apparatus to confine one or more manipulatable objects;
one or more arbitrary waveform generators (AWGs), wherein the one or more AWGs are operable to generate respective waveforms; and
a plurality of channel-dedicated signal processing assemblies, wherein each signal processing assembly of the plurality of channel-dedicated signal processing assemblies is configured to condition a voltage signal applied to a respective electrode of the plurality of electrodes, the signal processing assembly comprising:
a channel-dedicated voltage generator, and
an operational amplifier,
wherein the operational amplifier is configured to receive (i) a broadcasted waveform (a) generated by an AWG of the one or more AWGs and (b) broadcasted to at least two signal processing assemblies of the plurality of channel-dedicated signal processing assemblies and (ii) a quasi-static voltage generated by the channel-dedicated voltage generator, and
wherein the operational amplifier is configured to output a combined signal generated by combining the broadcasted waveform and the quasi-static voltage.

2. The system of claim 1, wherein the channel-dedicated voltage generator is a digital-analog converter (DAC).

3. The system of claim 1, wherein a quantity of AWGs in the one or more AWGs is less than a quantity of the plurality of channel-dedicated signal processing assemblies.

4. The system of claim 1, wherein the signal processing assembly comprises at least one filter configured to filter the combined signal.

5. The system of claim 4, wherein the operational amplifier is configured to amplify the combined signal such that a filtered combined signal generated by filtering the combined signal by the at least one filter has a desired amplitude.

6. The system of claim 1, further comprising a controller configured to control operation of the one or more AWGs and the plurality of channel-dedicated signal processing assemblies.

7. The system of claim 6, further comprising a plurality of calibration sensors, each calibration sensor configured to perform a calibration measurement corresponding to a respective location of the confinement apparatus and provide a respective sensor signal for receipt by the controller.

8. The system of claim 7, wherein the controller is configured to determine the quasi-static voltage to be generated by a respective channel-dedicated voltage generator based on respective sensor signals generated and provided by one or more calibration sensors of the plurality of calibration sensors.

9. The system of claim 8, wherein the quasi-static voltage is determined based on an existing electric field or electric potential at a particular location of the confinement apparatus determined based at least in part the respective sensor signals and a desired electric field or electric potential at the particular location.

10. The system of claim 1, wherein the combined signal is applied to a respective electrode of the plurality of electrodes corresponding to the signal processing assembly.

11. The system of claim 1, wherein each of the respective waveforms generated by the one or more AWGs are provided to a respective plurality of the channel-dedicated signal processing assemblies.

12. The system of claim 1, wherein the one or more AWGs comprises a first AWG and a second AWG and the broadcasted waveform is a switchable one of a first waveform generated by the first AWG or a second waveform generated by the second AWG is provided to the signal processing assembly.

13. The system of claim 1, wherein the system is quantum charge-coupled device (QCCD)-based quantum computer.

14. A method comprising:
determining, by a controller, a desired electric field or electric potential at a particular location defined by a confinement apparatus, wherein the confinement apparatus comprises one or more electrodes;
determining, by the controller, respective quasi-static voltages to be provided to the one or more electrodes to cause an electric field or electric potential at the particular location to be the desired electric field or electric potential, the quasi-static voltage determined based at least in part on a respective broadcasted waveform to be provided to the one or more electrodes and the desired electric field or electric potential; and
controlling, by the controller, respective channel-dedicated voltage generators of respective channel-dedicated signal processing assemblies to cause the respective channel-dedicated voltage generators to generate the respective quasi-static voltages, wherein respective operational amplifiers of the respective channel-dedicated respective channel-dedicated signal processing assemblies receive the respective broadcasted waveform and the respective quasi-static voltages and generate respective combined signals based thereon, and the respective combined signals are applied to respective electrodes of the one or more electrodes.

15. The method of claim 14, further comprising receiving one or more sensor signals, the one or more sensor signals generated by respective calibration sensors and indicating respective calibration measurements, wherein the respective calibration measurements indicate a current electric field or electric potential at the particular location.

16. The method of claim 15, wherein the respective quasi-static voltages are determined based at least in part on the current electric field or electric potential at the particular location.

17. The method of claim 14, wherein the respective channel-dedicated signal processing assemblies comprise respective filters configured to filter the respective combined signals prior to the respective combined signals are applied to the respective electrodes.

18. The method of claim 17, wherein the respective operational amplifiers are operated to amplify the respective combined signals such that respective filtered combined signals generated by filtering the respective combined signals by the respective filters have desired respective amplitudes.

19. The method of claim 14, wherein the respective broadcasted waveform is provided to a plurality of the respective channel-dedicated voltage generators.

20. The method of claim 14, wherein the respective broadcasted waveform is generated by an arbitrary waveform generator (AWG) and the respective channel-dedicated voltage generators are digital analog converters (DACs).
